(19) United States
(12) Patent Application Publication
(10) Pub. No.: US 2026/0032225 A1
(43) Pub. Date: Jan. 29, 2026

(54) INFORMATION PROCESSING APPARATUS, METHOD FOR CONTROLLING THE INFORMATION PROCESSING APPARATUS, AND STORAGE MEDIUM

(71) Applicant: CANON KABUSHIKI KAISHA, Tokyo (JP)

(72) Inventor: KINA ITAKURA, Kanagawa (JP)

(21) Appl. No.: 19/269,526

(22) Filed: Jul. 15, 2025

(30) Foreign Application Priority Data
Jul. 23, 2024 (JP) 2024-117836

(51) Int. Cl. H04N 13/122; G06F 3/01; H04N 13/00; H04N 13/344; H04N 13/383

(52) U.S. Cl. CPC H04N 13/122; H04N 13/344; H04N 13/383; G06F 3/013; H04N 2013/0077

(57) ABSTRACT

The present disclosure is directed to reducing stress on a user experiencing an XR video image using an HMD. To achieve this, an information processing apparatus generating a virtual reality image to be stereoscopically displayed with a head-mounted display device includes a first obtaining unit configured to obtain, as material data for generating the virtual reality image, a stereoscopic image capable of expressing two images having parallax from each other and information regarding the parallax corresponding to the stereoscopic image; and a generation unit configured to generate a virtual reality image applied to specific processing to make it easier for eyes of a user wearing the display device to focus in a case where a difference in parallax between different frames of the stereoscopic image is greater than a threshold.

### BACKGROUND

### Field of the Technology

The present disclosure relates to an image processing technique for an XR video image using a head-mounted display.

### Description of the Related Art

In recent years, a video image technique called cross reality (XR), such as virtual reality (VR) that allows users to experience virtual space as if the users were in real space by stereoscopically displaying a video image using CG, and mixed reality (MR) that mixes the real world with a virtual world, has made remarkable progress. Japanese Patent Laid-Open No. 2012-15620 discloses a technique for presenting a user with a region that is highly unlikely to be mixed as a single image at the time of viewing in capturing a stereoscopic image (stereo image) and for obtaining a stereo image that allows comfortable stereoscopic vision. Japanese Patent Laid-Open No. 2018-45459 also discloses a technique for arranging an information display object (UI) in an HMD wearer's line of sight direction in a VR system using the HMD to display the UI so as to follow a change in the wearer's line of sight.

### SUMMARY

An information processing apparatus according to the present disclosure is an information processing apparatus generating a virtual reality image to be stereoscopically displayed with a head-mounted display device, the information processing apparatus comprising: a first obtaining unit configured to obtain, as material data for generating the virtual reality image, a stereoscopic image capable of expressing two images having parallax from each other and information regarding the parallax corresponding to the stereoscopic image; and a generation unit configured to generate a virtual reality image applied to specific processing to make it easier for eyes of a user wearing the display device to focus in a case where a difference in parallax between different frames of the stereoscopic image is greater than a threshold.

Features of the present disclosure will become apparent from the following description of embodiments with reference to the attached drawings. The following description of embodiments are described by way of example.

### BRIEF DESCRIPTION OF THE DRAWINGS

FIG. 1A is a diagram showing a configuration example of a video image display system using an HMD, and FIG. 1B is a diagram showing an example of a hardware configuration of an information processing apparatus;

FIG. 2 is a functional block diagram showing a software configuration of the information processing apparatus;

FIGS. 3A and 3B are flowcharts showing a processing flow in a case where the information processing apparatus according to a first embodiment generates a VR image;

FIGS. 4A and 4B are diagrams for explaining the principles of stereoscopic vision;

FIG. 5A is a diagram showing a state where a wearer can stereoscopically observe an object by viewing a VR image through the HMD, and FIG. 5B is a diagram showing a relationship between material data on a moving image and a VR image displayed on the HMD;

FIG. 6A is an explanatory diagram of a three-dimensional unit vector, and FIG. 6B is an explanatory diagram of a certain range;

FIGS. 7A and 7B are block diagrams showing an internal configuration of the information processing apparatus according to modification examples of the first embodiment;

FIG. 8 is a flowchart showing an operation flow in a case where the information processing apparatus according to a first modification example of the first embodiment generates a VR image;

FIG. 9 is a flowchart showing an operation flow in a case where the information processing apparatus according to a second modification example of the first embodiment generates a VR image;

FIG. 10 is a functional block diagram showing a software configuration of the information processing apparatus according to a second embodiment;

FIGS. 11A and 11B are explanatory diagrams of a three-dimensional coordinate system representing three-dimensional space in which an HMD wearer exists;

FIG. 12 is a flowchart showing a processing flow in a case where the information processing apparatus according to the second embodiment determines and displays the position of a UI;

FIG. 13A is a diagram for explaining a process for calculating a visible region, and FIG. 13B is a diagram for explaining a process for determining the position of a UI based on the visible region and a gaze region;

FIG. 14A is a diagram showing a state where the HMD wearer is watching video image contents, and FIG. 14B is a diagram showing a state where a UI is displayed;

FIG. 15A is a block diagram showing an internal configuration of the information processing apparatus according to a first modification example of the second embodiment, and FIG. 15B is a block diagram showing an internal configuration of the information processing apparatus according to a second modification example of the second embodiment;

FIG. 16 is a flowchart showing a processing flow in a case where the information processing apparatus according to the first modification example of the second embodiment determines and displays the position of a UI;

FIG. 17 is a diagram for explaining the behavior of the UI in the first modification example of the second embodiment; and

FIG. 18 is a diagram showing the relationship between FIG. 18A and FIG. 18B; FIGS. 18A and 18B are flowcharts showing a processing flow in a case where the information processing apparatus according to the second modification example of the second embodiment determines and displays the position of a UI.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

In the present embodiment, an aspect is described in which parallax in each frame to achieve stereoscopic vision is adjusted in generating a VR video image to be displayed on a head-mounted display (HMD) so that the parallax is appropriate for a user (wearer) wearing the HMD.

### System Configuration

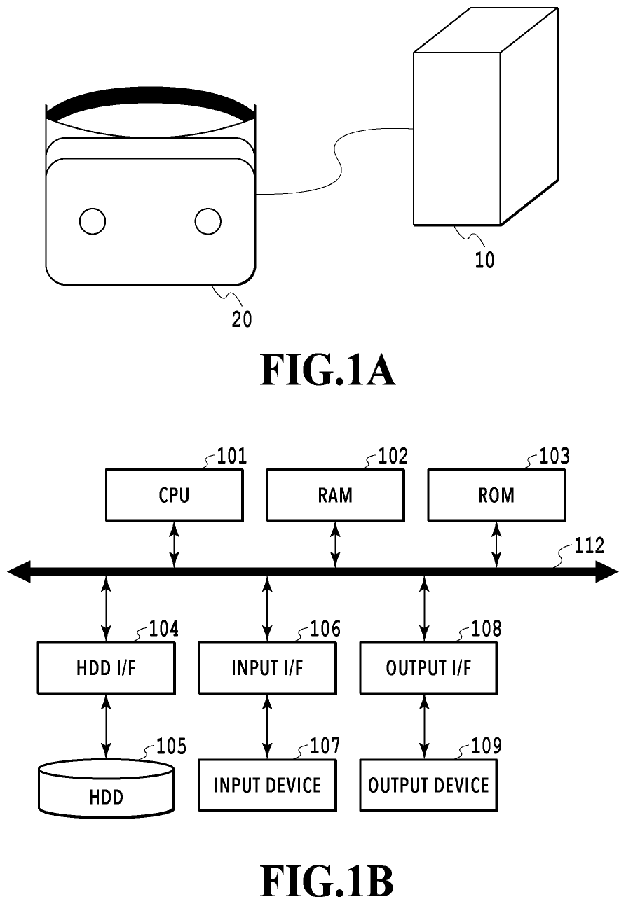

FIG. 1A is a diagram showing a configuration example of a video image display system using the HMD. The display system shown in FIG. 1A includes an information processing apparatus 10 that controls an HMD 20, and the HMD 20, which is a head-mounted display device. In the present embodiment, descriptions will be made using a system configuration in which the information processing apparatus 10 is independent of the HMD 20, but a configuration such as an integrated HMD system including the information processing apparatus 10 inside the HMD 20 may be used.

### Hardware Configuration of Information Processing Apparatus

FIG. 1B is a diagram showing an example of a hardware configuration of an information processing apparatus. In FIG. 1B, a CPU 101 executes programs stored in a ROM 103 and a hard disk drive (HDD) 105 using a RAM 102 as work memory to control the operation of each block described later via a system bus 112. An HDD interface (hereinafter, interface will be referred to as “I/F”) 104 connects a secondary storage device such as the HDD 105 or an optical disk drive. The HDD I/F 104 is, for example, an I/F such as a serial ATA (SATA). The CPU 101 can read data from the HDD 105 and write data to the HDD 105 via the HDD I/F 104. Further, the CPU 101 can expand data stored in the HDD 105 into the RAM 102, and conversely, can save data expanded into the RAM 102 to the HDD 105. The CPU 101 can execute the data expanded into the RAM 102 as a program. An input I/F 106 can connect an input device such as a keyboard, a mouse, or an HMD controller. The input I/F 106 is, for example, a serial bus I/F such as USB or IEEE1394. The CPU 101 reads data from an input device 107 via the input I/F 106. An output I/F 108 connects the information processing apparatus 10 to the HMD 20, which is an output device 109. The output I/F 108 is, for example, a video image output I/F such as DVI or HDMI (registered trademark), and/or a serial bus I/F such as USB or IEEE1394. The CPU 101 can send data to the output device 109 such as the HMD 20 via the output I/F 108 to display a predetermined video image. The CPU 101 also receives, from the HMD 20, information such as the position and orientation of the HMD 20 (hereinafter referred to as “HMD information”) while a wearer is experiencing the video image. The HMD information may be input via a mouse, a keyboard, a camera, or the like. Incidentally, the information processing apparatus 10 also includes components other than those described above, but since the components are not the main focus of the present disclosure, a description thereof will be omitted.

### Software Configuration of Information Processing Apparatus

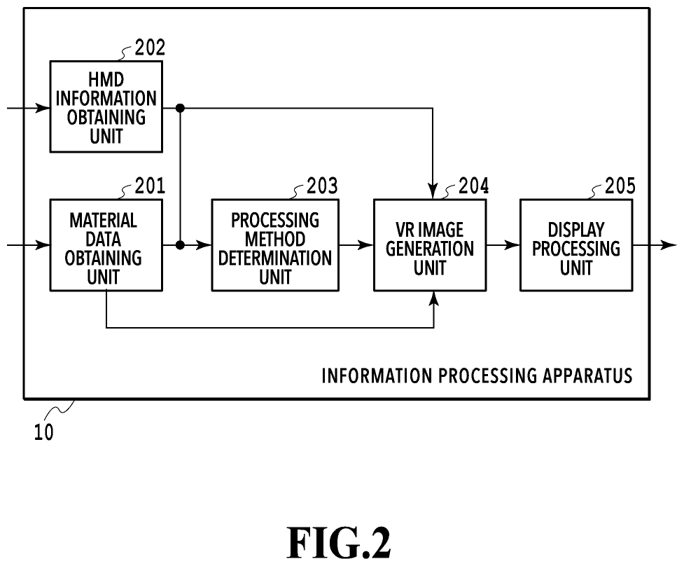

FIG. 2 is a functional block diagram showing a software configuration (logical configuration) of the information processing apparatus 10 according to the present embodiment. The information processing apparatus 10 according to the present embodiment includes a material data obtaining unit 201, an HMD information obtaining unit 202, a processing method determination unit 203, a VR image generation unit 204, and a display processing unit 205. Each unit will be described below.

The material data obtaining unit 201 obtains stereoscopic image data captured and stored in advance from the secondary storage device 105 or directly obtains stereoscopic image data immediately after capturing in real time. The stereoscopic image (stereo image) according to the present embodiment refers to two equirectangular images (a pair of left and right images) with parallax from each other captured with a VR camera with a wide viewing angle of 180 degrees or 360 degrees. The data format of the stereoscopic image may be any format such as a cube map format as long as two images with parallax from each other can be expressed. The obtained stereo image data is output to the VR image generation unit 204. The material data obtaining unit 201 also obtains information regarding the parallax corresponding to the stereo image obtained. This information regarding the parallax (hereinafter referred to as “parallax data”) is, for example, an image (parallax image) having a resolution equal to that of the stereo image, and pixel values in the parallax image indicate parallax values corresponding to respective pixels of a left viewpoint in the stereo image. The parallax image may be obtained as a combination prepared in advance with the stereo image or may be derived from the stereo image. As a method for derivation from the stereo image, for example, there is a method in which block matching is performed between left and right images constituting the obtained stereo image to find corresponding regions, or a method using machine learning. For example, in the case of a stereoscopic video image format called MV-HEVC, depth data indicating a distance to an object is included, and the depth data may be treated as parallax data. Incidentally, the parallax data has only to be in a data format that allows a parallax value for each object reflected in the stereo image to be obtained, and for example, each pixel value of the parallax image may indicate a parallax value corresponding to a right viewpoint. Further, the resolution of the parallax image does not necessarily have to be the same as the resolution of the stereo image and may be lower than the resolution of the stereo image. The obtained parallax data is output to the processing method determination unit 203.

The HMD information obtaining unit 202 obtains, as HMD information, information indicating the position and orientation of the HMD 20 while a wearer is experiencing a VR video image. The HMD 20 includes a plurality of RGB cameras (not shown) and an inertial measurement unit (IMU) (not shown) to realize position tracking by an inside-out method. The IMU is a device that detects three-dimensional inertial motion (translational motion and rotational motion in three orthogonal axial directions) and includes a gyro sensor that captures rotational motion and an acceleration sensor that captures translational motion. The IMU expresses the orientation (line-of-sight direction) of a wearer of the HMD 20 using a 3×3 rotation matrix in three-dimensional space, roll, pitch, and yaw. Incidentally, a method for expressing the orientation is not limited to this and may be another expression method such as quaternion. The HMD 20 may also have an eye tracking function such that the movement of the wearer's eyes can be tracked to identify what the wearer is actually looking at. The obtained HMD information is output to the processing method determination unit 203 and the VR image generation unit 204.

The processing method determination unit 203 determines a processing method for generating a virtual reality image (VR image) to be displayed on the HMD 20 based on the input HMD information and parallax data. In the present embodiment, it is determined based on the amount of change in parallax from a previous frame whether to generate the image by normal processing or by performing processing to make a match with the line of sight direction with small parallax. Information on a determined processing method is output to the VR image generation unit 204.

The VR image generation unit 204 generates a VR image for stereoscopic display according to the processing method determined by the processing method determination unit 203 using the stereo image input from the material data obtaining unit 201 based on the HMD information input from the HMD information obtaining unit 202. The generated VR image data is output to the display processing unit 205.

The display processing unit 205 converts the VR image input from the VR image generation unit 204 into an image suitable for viewing on the HMD 20 and outputs the image to the HMD 20. The conversion here includes color conversion processing suitable for a built-in display of the HMD 20, correction processing for correcting distortion of eyepiece lens of the HMD 20, and the like.

### Operation Flow of Information Processing Apparatus

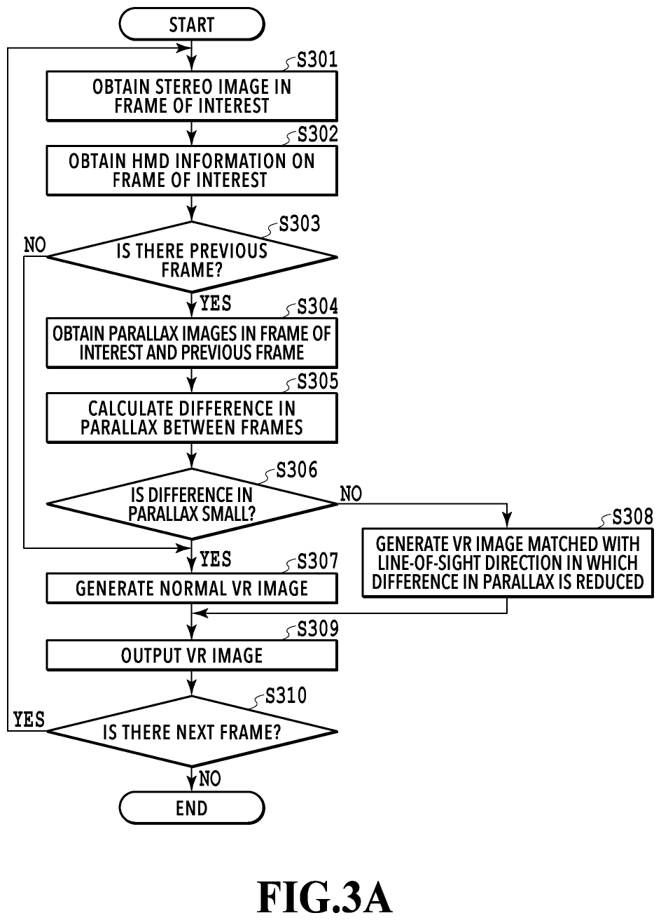

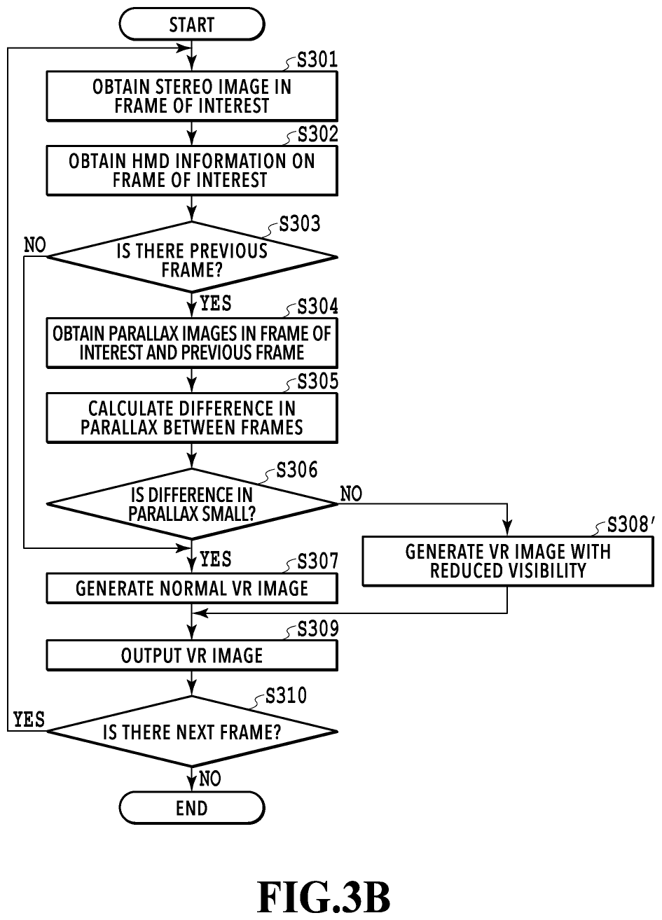

Next, a processing flow in a case where the information processing apparatus 10 according to the present embodiment generates a VR image will be described with reference to the flowchart in FIG. 3A. A series of steps shown in the flowchart in FIG. 3A is implemented by the CPU 101 expanding a program stored in the ROM 103 into the RAM 102 and executing the program. In the present embodiment, a data set of stereo image of a moving image that has been captured and stored in advance and a parallax image corresponding to the stereo image is read from the HDD 105, and processing is started in response to an instruction from a wearer to start viewing a VR video image and is executed in units of frames. Incidentally, it is not necessary for all steps shown in the flowchart in FIG. 3A to be executed by the CPU 101, and a portion or all of the steps may be executed with one or more processing circuits other than the CPU 101. Incidentally, in the following description, each symbol “S” means a step.

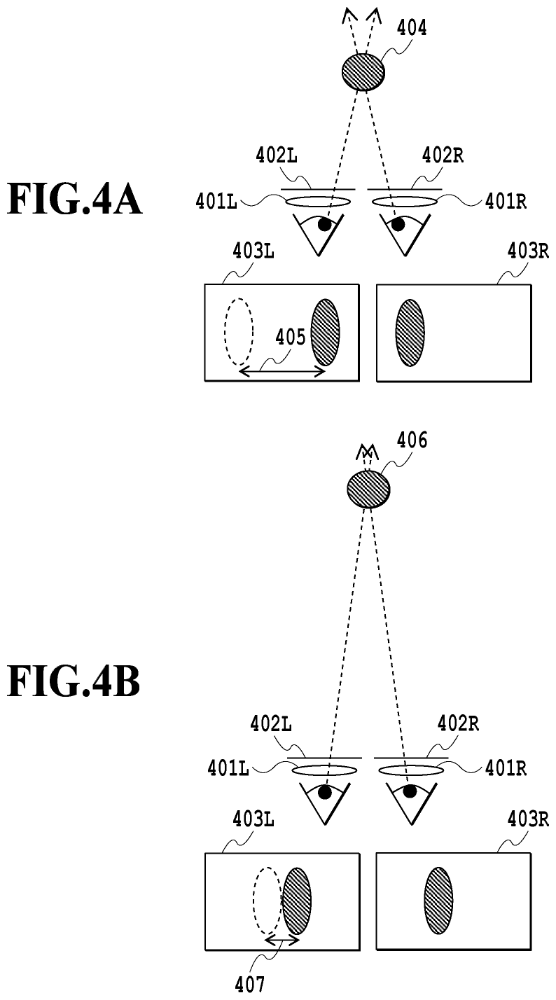

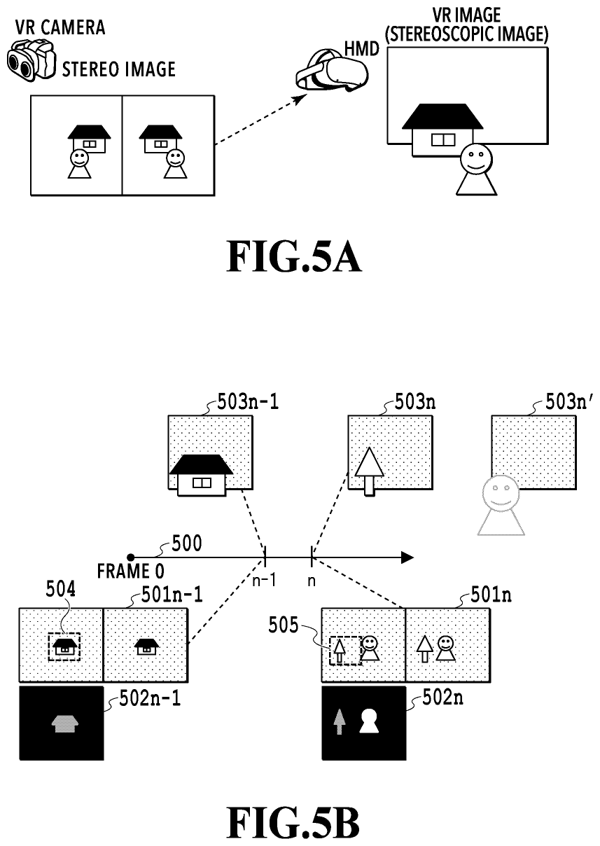

In S301, the material data obtaining unit 201 obtains stereo image in a frame of interest from a data set of input stereo image and a corresponding parallax image. Here, the stereo image obtained in the present step and the parallax image to be obtained in S304 described later will be described with reference to the drawings. As a premise, first, the principles of stereoscopic vision will be described with reference to FIGS. 4A and 4B. The HMD 20 has lenses 401R, 401L and displays 402R, 402L arranged in front of left and right eyes, respectively. A user wearing the HMD 20 can perceive an image as a virtual image by viewing the displays 402R, 402L through the lenses 401R, 401L with the left and right eyes, respectively. At this time, by displaying different images with parallax on the displays 402R, 402L, the wearer receives a three-dimensional appearance from the virtual image due to binocular parallax. The position of this virtual image varies depending on the amount of parallax between the images displayed on the displays 402R, 402L. For example, in a case where the positions of the same object 404 in a right-eye image 403R and a left-eye image 403L are significantly different and parallax 405 is large as shown in FIG. 4A, the wearer perceives the object 404 as being relatively close. On the other hand, in a case where the positions of the same object 406 in the right-eye image 403R and the left-eye image 403L are not so different and parallax 407 is small as shown in FIG. 4B, the wearer perceives the object 406 as being relatively far away. As shown in FIG. 5A, viewing a VR image based on stereo image captured with a VR camera on the HMD 20 allows the wearer to observe the object stereoscopically. FIG. 5B is a diagram showing a relationship between material data on a moving image and a VR image displayed on the HMD 20. In FIG. 5B, the lower side of a right-pointing arrow 500 representing a time axis in the center shows material data, and the upper side shows VR images. In the present step, stereo image 501ₙ relating to a frame of interest (the nth frame in the figure) are obtained, and a corresponding parallax image 502ₙ is obtained in S304 described later. The parallax image 502ₙ is expressed darker as the parallax is smaller, and is expressed brighter as the parallax is larger. The obtained stereo image data in the frame of interest is output to the VR image generation unit 204. Incidentally, the configuration shown in FIG. 4A is an example and may be, for example, a configuration including one display and two lenses may be used. Any configuration may be used as long as the HMD enables stereoscopic vision.

In S302, the HMD information obtaining unit 202 obtains HMD information indicating the current position and orientation of the HMD 20. The obtained HMD information is output to the processing method determination unit 203 and the VR image generation unit 204.

In S303, a step to be executed next is determined depending on whether there is a frame immediately preceding the frame of interest. In a case where there is a previous frame, S304 is executed. On the other hand, in a case where the frame of interest is a leading frame and where there is no previous frame, S307 is executed next. In the example in FIG. 5B described above, since there is an n−1th frame with reference to the nth frame, which is the frame of interest, S304 is executed.

In S304, the material data obtaining unit 201 obtains parallax images in the frame of interest and the previous frame. In the example in FIG. 5B described above, a parallax image 502ₙ in the nth frame and a parallax image 502ₙ₋₁ in the n−1th frame are obtained. The obtained the parallax image data in the frame of interest and the previous frame is output to the processing method determination unit 203.

In S305, the processing method determination unit 203 calculates a difference in the amount of parallax between the frame of interest and the previous frame based on the parallax images in the frame of interest and the previous frame obtained in S304. Specifically, first, a difference between the parallax image in the frame of interest and the parallax image in the previous frame is calculated for each pixel in a correspondence relationship. Next, based on orientation information on the HMD 20 included in the HMD information, a region in the stereo image that the wearer is looking at (hereinafter referred to as “observation region”) is identified, and the average value of difference values between all pixels included in the region of the parallax image corresponding to the observation region is calculated. Finally, the calculated average value is set as a difference in the amount of parallax between the two frames. Incidentally, the method for calculating the difference in the amount of parallax is not limited to this. For example, the median value, mode value, or the like of all pixels in the region of the parallax image that the wearer is looking at may be used as long as a representative difference in the amount of parallax in an identified region is indicated.

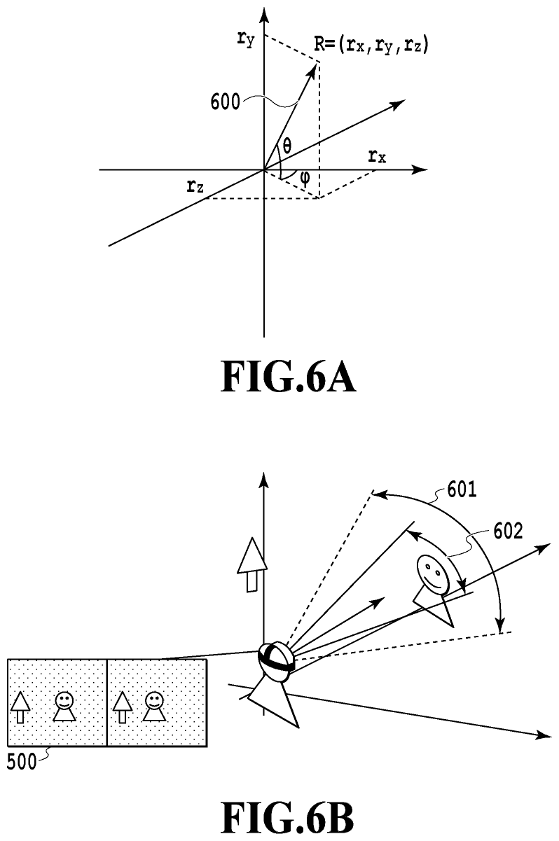

In S306, the processing method determination unit 203 determines what type of VR image is to be generated and a processing method for generating the VR image to be generated for the frame of interest based on the difference in the amount of parallax between the frame of interest and the previous frame calculated in S305. A step to be executed next is then determined according to the determined contents. In the present embodiment, in a case where the calculated difference in the amount of parallax is equal to or less than a predetermined threshold, it is determined to generate a VR image by a normal processing method, and in a case where the difference exceeds the threshold, it is determined to generate a VR image by a processing method accompanied with processing to make a match with a line-of-sight direction in which the difference in the amount of parallax is reduced. Once the processing method in generating a VR image is determined, the type of VR image according to the method (i.e., whether to generate a normal VR image or to generate a VR image matched with the line-of-sight direction in which the difference in the amount of parallax is reduced) is determined. Here, the threshold is set to, for example, a value which is 30% of a difference between a minimum parallax value and a maximum parallax value in the parallax image. It is only required that the threshold be an index suitable for determining whether the difference in the amount of parallax between the frame of interest and the previous frame is small, such as one set uniformly regardless of the type of stereo image. As a result of threshold processing, in a case where it is determined to generate a VR image matched with the line-of-sight direction in which the difference in the amount of parallax is reduced, the processing method determination unit 203 further generates additional information indicating the line-of-sight direction. This additional information is expressed as a three-dimensional unit vector in virtual space. This additional information is first obtained by obtaining a three-dimensional unit vector indicating a direction in which the wearer of the HMD 20 is facing from the orientation information included in the HMD information. FIG. 6A is an explanatory diagram of the three-dimensional unit vector, and an arrow 600 in the figure indicates the direction in which the wearer is facing. Next, in the parallax image in the frame of interest, the average value of parallax values between all pixels included in a certain range centered on the direction of the obtained three-dimensional unit vector is obtained, and the obtained average value is set as the representative parallax value of the frame of interest. FIG. 6B is a diagram for explaining the certain range. Now, in FIG. 6B, it is assumed that a viewing angle at which viewing is possible on the HMD 20 is 90 degrees and that the wearer is facing in the direction of a person in the stereo image 500 and can view a range 601 indicated by the dashed line in the figure. In this case, a range in which a person can receive information without moving the person's line of sight (for example, a range 602 where a viewing angle is 30 degrees) is a certain range in this case. A region having a parallax value close to the representative parallax value of the frame of interest is identified from a parallax image in a next frame. Finally, there is obtained a three-dimensional unit vector in a case where the center of the identified region is set as a line-of-sight direction, and the obtained three-dimensional unit vector is used as additional information. This additional information is output to the VR image generation unit 204. In this way, in a case where it is determined to generate a normal VR image, S307 is executed next, and in a case where it is determined to generate a VR image matched with a line-of-sight direction in which the difference in the amount of parallax is reduced, S308 is executed next.

In S307, the VR image generation unit 204 generates a VR image to be displayed on the HMD 20 using a normal processing method based on the stereo image in the frame of interest obtained in S301 and the HMD information obtained in S302. Specifically, first, the direction in which the wearer is facing in three-dimensional space is obtained as a three-dimensional unit vector from the orientation information included in the HMD information. Rendering is then performed according to the display angle of view of the HMD 20 based on the direction of the obtained three-dimensional unit vector. The display angle of view at this time is a fixed value dependent on the HMD 20 and is defined according to the viewing angle and a panel resolution. Further, the rendering is a process for generating a perspective projection image from equirectangular stereo image and has only to use a general three-dimensional rendering method.

In S308, the VR image generation unit 204 generates a VR image by a processing method accompanied with a process for making a match with the line-of-sight direction in which the difference in the amount of parallax is reduced based on the stereo image in the frame of interest obtained in S301 and the additional information generated in S306. That is, based on the direction of the three-dimensional unit vector as the additional information, rendering is performed according to the display angle of view of the HMD 20 to generate a perspective projection image based on the stereo image. Here, with reference to FIG. 5B mentioned above, a specific example will be used to describe the VR image to be generated in the present step. In FIG. 5B, images 503 arranged on the upper side of the right-facing arrow 500 representing the time axis are VR images cut out from the stereo image 501 with a wide viewing angle in accordance with the position and orientation of the wearer. For example, a VR image 503ₙ₋₁ is a VR image corresponding to a region 504 indicated by a dashed line in stereo image 501ₙ₋₁ in a frame ₙ₋₁ immediately before a frame ₙ. The VR images 503ₙ and 503_{n′} are VR images cut out from the stereo image 501ₙ in the frame ₙ in accordance with the position and orientation of the wearer. Now, it is assumed that the position and orientation of the wearer have not changed since a frame ₙ₋₁ in generating a VR image with the frame ₙ as a frame of interest. In this case, in a case where a difference between parallax in the corresponding region of the parallax image 502ₙ₋₁ and parallax in the corresponding region of the parallax image 502ₙ is small, image generation is performed in S307 (Yes in S306). However, a color representing the amount of parallax in the corresponding region of the parallax image 502ₙ₋₁ is now gray, while a color representing the amount of parallax in the corresponding region of the parallax image 502ₙ is white, and the difference is not small. Thus, image generation is performed in S308 (No in S306). A region where the line of sight direction is shifted to the left so that the difference in the amount of parallax is reduced, that is, a region corresponding to the region 505 centered on a gray portion and indicated by the dashed line in the parallax image 502ₙ,is then cut out from the stereo image 501ₙ to generate a VR image. As a result, a VR image 503ₙ is obtained in which a standing tree can be viewed stereoscopically in a position far from the wearer. This eliminates the need for the wearer's eyes to refocus and suppresses eye strain.

As shown in the flowchart in FIG. 3B, instead of S308 described above, a process for reducing the visibility of the object may be performed (S308′). The process for reducing the visibility includes adding a blur, reducing a luminance value, reducing a contrast, reducing a color difference, and the like. In this case, the process for reducing the visibility has only to be additionally performed after performing rendering according to the orientation information obtained in S302. The VR image 503_{n′} in FIG. 5B shows a VR image with blurring. In this case, since the line of sight is not changed, a region centered on a white portion in the parallax image 502ₙ is cut out from the stereo image 501ₙ,and a VR image is generated in which a person can be viewed stereoscopically in a position close to the wearer, but the outline of the person is blurred. The process for reducing the visibility may be performed for the entire region of the perspective projection image after rendering or may be performed only for a region with a large difference in the amount of parallax based on parallax data. Further, the process for reducing the visibility of the object may be additionally performed after performing rendering to change the line-of-sight direction to one in which the difference in the amount of parallax is reduced. Alternatively, the change of the line-of-sight direction or the reduction of visibility may be selectively applied. In the case of selective application, the selection may be made before starting the execution of the present flow or may be made according to the contents of an input stereo video image. For example, it may be dynamically determined to reduce the visibility in a case where there is no region having an equal amount of parallax between a frame of interest and a previous frame, and to change the line-of-sight direction in a case where there is a region having an equal amount of parallax between a frame of interest and a previous frame. Since a VR image with reduced visibility can divert the wearer's attention from an object with a large change in parallax (≈distance), there is no need for forced focusing, and similarly, eye strain can be suppressed.

In S309, the display processing unit 205 performs necessary conversion processing on the VR image generated in S308 in the frame of interest for display on the HMD 20, and outputs the VR image to the HMD 20. The HMD 20 displays the converted VR image received from the information processing apparatus 10 on the displays 402R, 402L.

In S310, it is determined whether there is a next frame. In a case where there is a next frame, the process returns to S301 and continues with the next frame as a frame of interest. On the other hand, in a case where there is no next frame, the process ends.

The above is the operation flow in generating a VR image according to the present embodiment. In the present embodiment, what type of VR image is to be generated (the processing method in generating a VR image) is determined based on the difference in the amount of parallax indicated by parallax data on previous and subsequent frames, but the same can be applied to a case where depth data is used instead of parallax data. This is because there is a correlation between the two (the greater the parallax is, the larger the distance is, and the smaller the parallax is, the smaller the distance is). Thus, in using the depth data, it is only required that control be performed to generate a VR image matched with the line-of-sight direction so that in a case where a change in distance to an object shown by the depth data is large, the change in distance is reduced. In the present embodiment, a case where a VR image is generated and displayed based on a data set of specific stereo image captured and stored in advance and a corresponding parallax image has been described as an example, but the present disclosure is not limited to this. For example, stereo image data captured with a VR camera may be obtained in real time to generate and display a VR image while deriving a parallax image from the obtained stereo image in real time. In this case, the VR image is generated and displayed in consideration of resources, image quality, and the like by, for example, reducing the resolution of the parallax image.

### First Modification Example

Even in the case of a video image with a large difference in the amount of parallax between previous and subsequent frames, in a case where the degree of influence on a wearer's vision is low (where the proportion of a region with a large difference in the amount of parallax in a VR image is small, where the region is blurred, or the like), the wearer is less likely to feel difficulty in focusing. Thus, in a case where the difference in the amount of parallax is large, the degree of influence on the wearer's vision is further calculated. Only in a case where the degree of influence on the vision is high, specific processing (i.e., processing for changing the line-of-sight direction or reducing visibility) for making it easier for the wearer to adjust the focus of the eyes may be performed to generate a VR image.

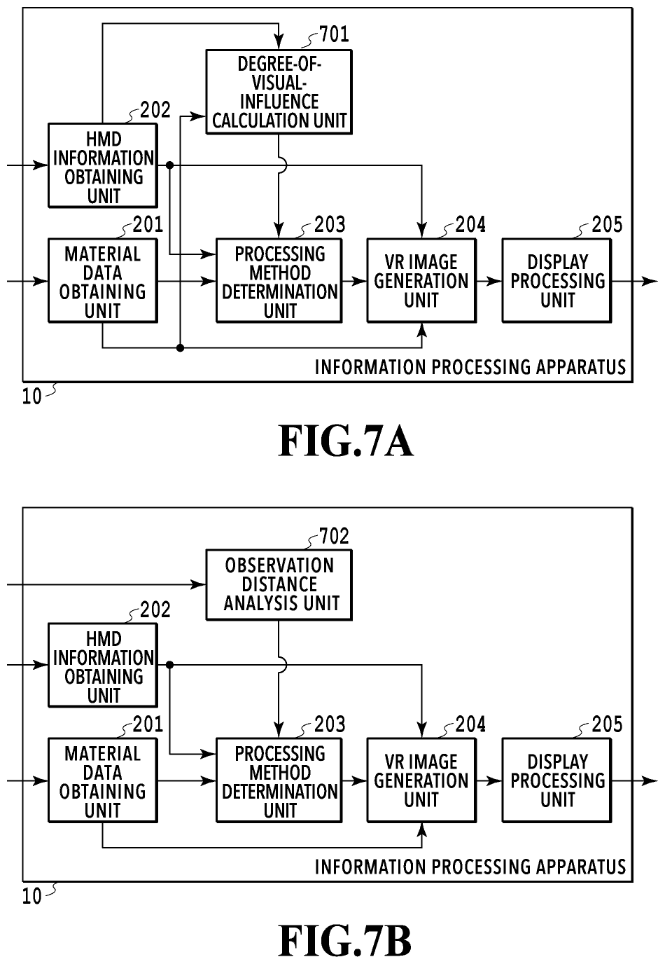

FIG. 7A is a block diagram showing an internal configuration of the information processing apparatus 10 according to the present modification example. A difference from the block diagram shown in FIG. 2 above is that a degree-of-visual-influence calculation unit 701 is added. In the present modification example, the material data obtaining unit 201 outputs obtained material data to the degree-of-visual-influence calculation unit 701 as well as to the VR image generation unit 204. The HMD information obtaining unit 202 outputs obtained HMD information to the degree-of-visual-influence calculation unit 701 as well as to the processing method determination unit 203 and the VR image generation unit 204. The degree-of-visual-influence calculation unit 701 calculates the degree of visual influence based on stereo image included in material data obtained from the material data obtaining unit 201 and HMD information obtained from the HMD information obtaining unit 202. A specific calculation method will be described later. The degree-of-visual-influence calculation unit 701 outputs the calculated degree of visual influence to the processing method determination unit 203. The processing method determination unit 203 determines what kind of VR image to display on the HMD 20 based on the input HMD information, parallax data included in the material data, and the degree of visual influence. A specific determination method will be described later.

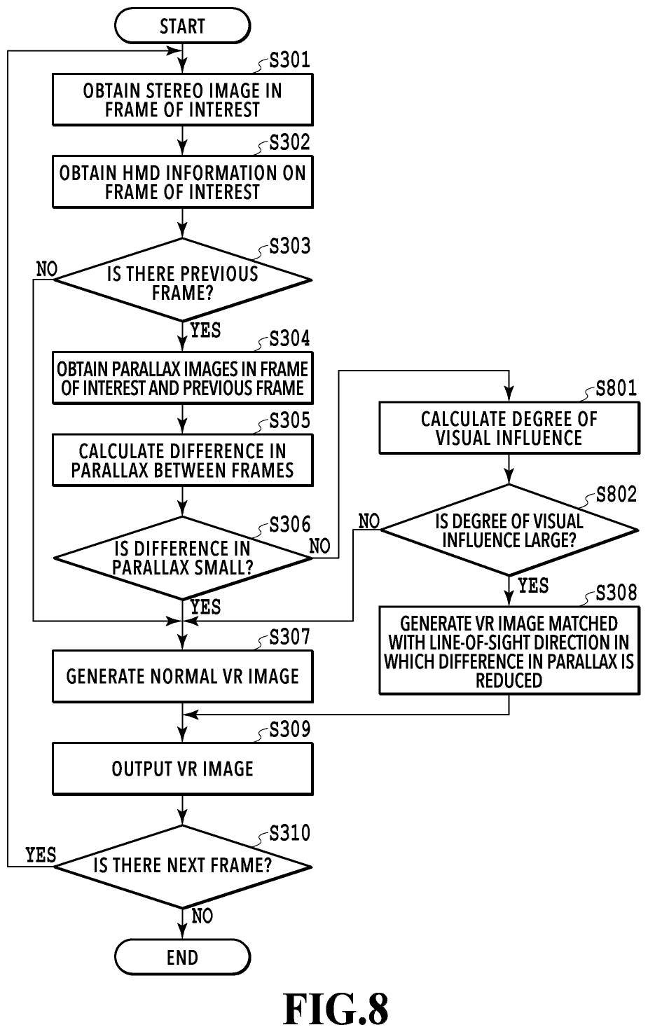

FIG. 8 is a flowchart showing an operation flow in a case where the information processing apparatus 10 according to the present modification example generates a VR image. The following description will be given with reference to the flowchart in FIG. 8, but the same reference number is given to the same step as in the flowchart in FIGS. 3A and 3B according to the above-mentioned first embodiment, and a description thereof will be omitted.

In S801 where the calculated difference in the amount of parallax exceeds a predetermined threshold, the degree-of-visual-influence calculation unit 701 calculates the degree of visual influence in an observation region in stereo image. The degree of visual influence is a scalar value having a value greater than or equal to 0 and less than or equal to 1, and the larger the value is, the larger the degree of visual influence is. In calculating the degree of visual influence, first, an observation region in stereo image is identified based on orientation information included in HMD information. Next, a region corresponding to an object in the identified observation region is detected. For example, semantic region division is performed on the observation region using machine learning to detect the region corresponding to the object at the center. Alternatively, based on a parallax image, a region at the center of a region of a pixel group having the same amount of parallax may be detected as the region corresponding to the object. Incidentally, regarding the region corresponding to the object to be detected, the object does not have to be an object at the center of the observation region. For example, the region corresponding to the object may be detected by identifying what the wearer is looking at using line-of-sight information obtained using the above-mentioned eye tracking function. After the detection of the region corresponding to the object is completed, the degree of visual influence is then calculated by making an evaluation from a viewpoint such that the higher the visibility of the object in the observation region is, the larger the degree of vision influence is, specifically, from the viewpoints of the size, blur amount, and luminance of the object. Representative evaluation methods for each viewpoint are as follows.

### Viewpoint of Size

The degree of visual influence in terms of size is calculated by dividing the total number of pixels of the detected region corresponding to the object by the total number of pixels of the observation region.

### Viewpoint of Blurring

The degree of visual influence in terms of blurring is obtained by calculating a blur amount from the detected region corresponding to the object using a known blur detection method such as Fourier transform.

### Viewpoint of Luminance

The degree of visual influence in terms of luminance is calculated by converting the pixel value of the detected region corresponding to the object into a luminance value and then dividing the average value of the region corresponding to the object by the maximum pixel value of an image (255 for an 8-bit image).

As described above, the degree of visual influence according to each viewpoint is calculated. The degree of visual influence may be determined as the value of the degree of visual influence by selecting one of the following viewpoints or may be determined as the value of the degree of visual influence by combining a plurality of viewpoints. In combining a plurality of viewpoints, any method may be used as long as one value is determined as the value of the degree of visual influence, such as taking the product of values calculated by the calculating methods for the viewpoints.

In subsequent S802, the processing method determination unit 203 determines to generate a normal VR image in a case where the calculated degree of visual influence is equal to or less than a predetermined threshold, and determines to generate a VR image matched with a line of sight direction in which the difference in the amount of parallax is reduced in a case where the calculated degree of visual influence exceeds the threshold. In this way, in a case where it is determined to generate a normal VR image, S307 is executed next, and in a case where it is determined to generate a VR image matched with the line of sight direction in which the difference in the amount of parallax is reduced, S308 is executed next. Since subsequent steps are the same as in the above embodiment, a description thereof will be omitted.

The above is the operation flow in generating a VR image with the information processing apparatus 10 according to the present modification example. In this way, even in a case where the difference in the amount of parallax between previous and subsequent frames is large, a normal VR image may be generated in a case where the degree of influence on a wearer's vision is small.

### Second Modification Example

Even in the case of a video image with a large difference in the amount of parallax between previous and subsequent frames, in a case where a distance to an object observed by a wearer (hereinafter referred to as “observation distance”) is not constant but varies, the wearer is less likely to feel difficulty in focusing. Thus, in a case where the difference in the amount of parallax is large, a change in the observation distance may be further checked, and depending on the presence or absence (or the degree) of a variation in the observation distance, it may be determined whether to generate a normal VR image or a VR image with a changed line-of-sight direction (and/or reduced visibility).

FIG. 7B is a block diagram showing an internal configuration of the information processing apparatus 10 according to the present modification example. A difference from the block diagram shown in FIG. 2 above is that an observation distance analysis unit 702 is added. In the present modification example, the material data obtaining unit 201 outputs obtained material data to the observation distance analysis unit 702 as well as to the VR image generation unit 204. The HMD information obtaining unit 202 outputs obtained HMD information to the processing method determination unit 203 and the VR image generation unit 204. The observation distance analysis unit 702 analyzes a distance to an object observed by a wearer, and outputs information indicating a change over time in the observation distance (time elapsed from the start of use of the current observation distance) to the processing method determination unit 203. The processing method determination unit 203 determines a processing method in generating a VR image to be displayed on the HMD 20 based on the input HMD information, parallax data included in the material data, and information on the change over time in the observation distance. A specific determination method will be described later.

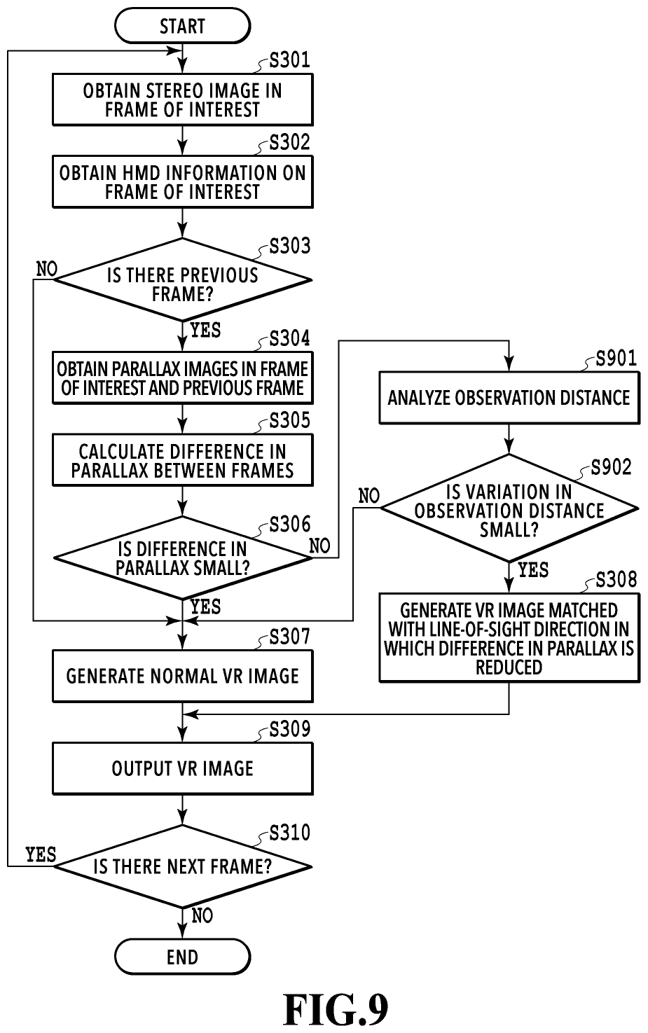

FIG. 9 is a flowchart showing the operation flow in a case where the information processing apparatus 10 according to the present modification example generates a VR image. The following description will be given with reference to the flowchart in FIG. 9, but the same reference number is given to the same step as in the flowchart in FIGS. 3A and 3B according to the above-mentioned first embodiment, and a description thereof will be omitted.

In S901 where the calculated difference between the amounts of parallax exceeds a predetermined threshold, the observation distance analysis unit 702 analyzes a change over time in a distance to an object observed by a wearer. Specifically, for example, a distance to an object reflected in input stereo image is obtained, elapsed time is reset at the timing of the distance being changed due to scene switching, and time from that point in time is measured. Unless there is a change at a certain level or more in the distance to the object, the elapsed time continues to be measured. In this case, the method for obtaining the distance to the object is not specifically limited. For example, the distance can be obtained by calculating the amount of parallax of the object focused on by the wearer from a parallax image corresponding to the stereo image based on orientation information included in HMD information and converting the amount of parallax into a distance by the principles of triangulation. Alternatively, the distance may be obtained by calculating the convergence angle of left and right eyes using the above-mentioned eye tracking function and converting the convergence angle into a distance. Incidentally, the timing of resetting the elapsed time is not limited to the above case, and for example, in a case where a change at a certain level or more is detected in the orientation information on the wearer, the elapsed time may be reset to measure time during which the same orientation is maintained in the same manner. The information thus obtained on the elapsed time during which a state where no change in the observation distance is observed continues is output to the processing method determination unit 203.

In S902, in a case where the elapsed time at the present time exceeds a predetermined threshold (a variation in the observation distance is small), the processing method determination unit 203 determines to generate a VR image matched with the line-of-sight direction in which the amount of parallax is reduced. On the other hand, in a case where the elapsed time at the present time is within a predetermined threshold (the variation in the observation distance is large), the processing method determination unit 203 determines to generate a normal VR image. In this way, in a case where it is determined to generate a normal VR image, S307 is executed next, and in a case where it is determined to generate a VR image matched with the line-of-sight direction in which the difference in the amount of parallax is reduced, S308 is executed next. Since subsequent steps are the same as in the above embodiment, a description thereof will be omitted.

The above is the operation flow in a case where the information processing apparatus 10 generates a VR image according to the present modification example. In this way, even in a case where there is a large difference in the amount of parallax between previous and subsequent frames, a normal VR image may be generated in a case where the observation distance varies.

As described above, according to the present embodiment including the various modification examples, in experiencing a stereoscopically viewable VR video image using the HMD, a wearer can easily focus on an object, thereby suppressing the occurrence of eye strain on the wearer.

### Second Embodiment

In watching video images or playing video games using an HMD, it is necessary to display a window-shaped user interface (hereinafter, simply referred to as “UI”) on a display to present various pieces of information to a user during the progress of experience or to input commands. At this time, the HMD can express wide-range virtual space such as space for 180 degrees or 360 degrees around, so that depending on a position where the UI is displayed, a wearer may not be able to recognize the UI, or the UI may overlap an object at which the wearer is gazing, which may interfere with video image viewing. Thus, an aspect in which a UI is displayed in an appropriate position in watching a video image using the HMD will be described as a second embodiment. Incidentally, a description of contents which are the same as in the first embodiment, such as the system configuration and the hardware configuration of the information processing apparatus, will be omitted, and differences will be mainly described below.

### Software Configuration of Information Processing Apparatus

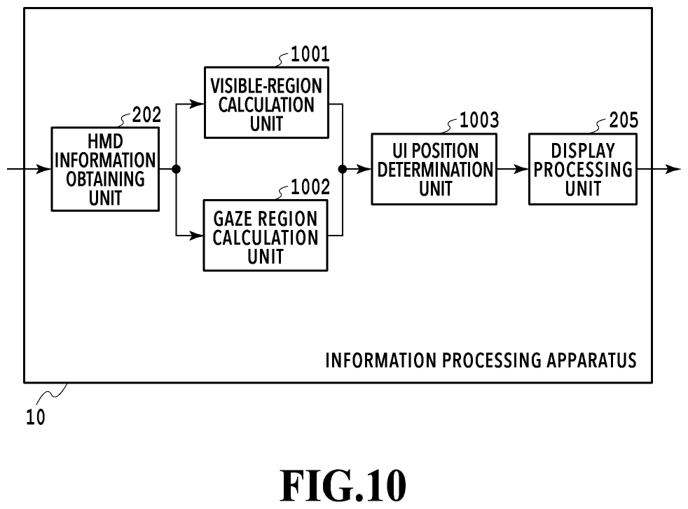

FIG. 10 is a functional block diagram showing a software configuration (logical configuration) of the information processing apparatus 10 according to the present embodiment. The information processing apparatus 10 according to the present embodiment includes an HMD information obtaining unit 202, a visible-region calculation unit 1001, a gaze region calculation unit 1002, a UI position determination unit 1003, and a display processing unit 205. Each unit will be described below.

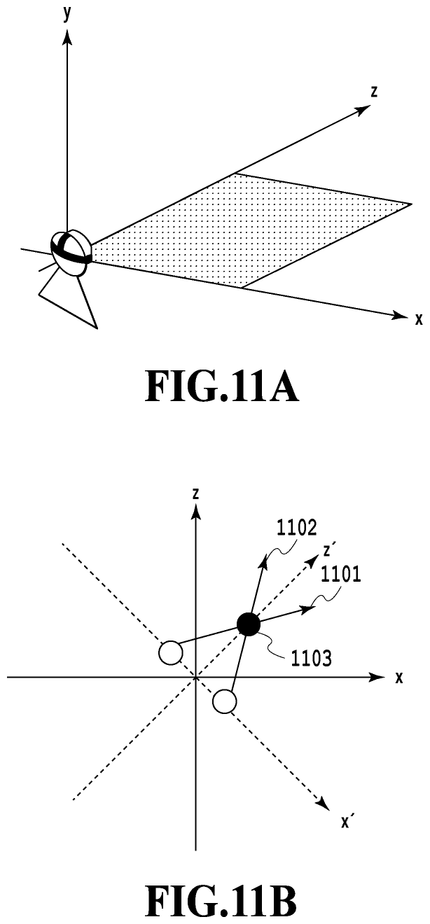

The HMD information obtaining unit 202 obtains HMD information indicating the position and orientation of the HMD 20 while a wearer is experiencing video image contents. The HMD 20 in the present embodiment has the above-mentioned eye tracking function, and the HMD information also includes line-of-sight information that can identify what the wearer is looking at. Here, the HMD information in the present embodiment will be clarified. The line-of-sight information included in the HMD information in the present embodiment is information that can be derived from orientation information on the HMD 20 and eyeball information on a wearer, and is data indicating a position in three-dimensional space at which the wearer is gazing. This line-of-sight information is expressed using coordinate values in a three-dimensional coordinate system that indicate three-dimensional space where the wearer of the HMD 20 exists. In the present embodiment, as shown in FIG. 11A, the three-dimensional coordinate system uses an x-axis that represents a distance in a horizontal direction, a y-axis that represents a distance in the vertical direction, and a z-axis that represents a distance in a depth direction with reference to a wearer. This three-dimensional coordinate system is fixed regardless of the movement of the wearer, and a reference state is required to define a coordinate system in space where the wearer uses the HMD 20. The reference state is the state of the wearer at the start of the operation of the HMD 20, the state of the wearer in a case where the position/display reset function of the HMD 20 is performed, or the like. The orientation information, which is one of the two pieces of information necessary for deriving the line-of-sight information, is expressed as a 3×3 rotation matrix in the three-dimensional coordinate system x-y-z, which identifies a direction in which the wearer is currently facing. For example, coordinates x′ and z′ indicated by the dashed line in FIG. 11B are identified as a horizontal-direction coordinate and a depth-direction coordinate, respectively. The eyeball information, which is the other piece of information necessary for deriving the line-of-sight information, is expressed as a direction vector in a three-dimensional coordinate system based on the position s of the wearer's eyeballs. In FIG. 11B, an arrow 1101 represents the direction vector of a left eye, and an arrow 1102 represents the direction vector of a right eye. From these two direction vectors and eye widths, the three-dimensional coordinate values of an intersection 1103 of the two direction vectors on coordinate axes x′-y′-z′, which represents a direction in which the wearer is currently facing, represent a position at which the wearer is currently gazing. Further, the three-dimensional coordinate values of the intersection 1103 are converted into three-dimensional coordinate values on the reference coordinate axes x-y-z using the rotation matrix. The converted three-dimensional coordinate values are line-of-sight information representing a position in three-dimensional space at which the wearer is gazing. As the information on the eye widths of the wearer, for example, a distance between eyepiece lenses held inside the HMD 20, the eye widths of the wearer included in the eyeball information, a predetermined fixed value, or the like may be used as appropriate. Here, the example of deriving the line-of-sight information using the orientation information and the eyeball information has been described, but the line-of-sight information may be derived using only the orientation information, for example. In this case, coordinate values (0, 0, d) on the coordinate axes x′-y′-z′ have only to be converted into three-dimensional coordinate values on the reference coordinate axes x-y-z using a fixed value d predetermined as a depth direction for the wearer. The line-of-sight information may also be derived in consideration of a change in the position of the wearer. In this case, translation components from the reference state included in the orientation information have only to be added to the coordinate values on the coordinate axes x′-y′-z′. Further, the expressions of the orientation information and the eyeball information are not limited to the above examples, and any expressions may be used. The HMD information obtaining unit 202 outputs the obtained HMD information to the visible-region calculation unit 1001 and the gaze region calculation unit 1002. The visible-region calculation unit 1001 calculates a visible region visible to a wearer based on HMD information input from the HMD information obtaining unit 202. Here, “visible region” means a region in which the wearer can recognize an object in a case where the wearer moves the wearer's line of sight within a reasonable range without moving the wearer's head. This visible region is expressed as the values of a set of the coordinate values of the center and the radius r of a circle on the reference coordinate axes x-y-z. The coordinate values of the center are the line-of-sight information itself. The radius r is obtained by z1×tan(θ/2) based on a predetermined angle of view θ and a distance z1 between the wearer's current position and a position in the three-dimensional space at which the wearer is gazing. The distance z1 is obtained by using the Euclidean distance in the three-dimensional space from the orientation information and the line-of-sight information. The predetermined angle of view θ is determined based on the visual characteristics of a person, and is an angle (e.g., 30 degrees) corresponding to a range in which the person can move the person's line of sight without any difficulty and a range in which the person can receive information without moving the person's line of sight. The value of the radius r may be different for each axis, and in that case, the angle of view θ is calculated by using different values for the horizontal x-axis and the vertical y-axis. For the z-axis, a distance shifted by a predetermined parallax angle ϕ from a distance at which the wearer is gazing is obtained, and a difference between the two distances is set as the value of the radius r. The parallax angle ϕ at this time is also determined based on the visual characteristics of a person, and is, for example, 5 degrees, which is an angle at which the person can perform divergence and convergence movements of eyeballs without any difficulty. The method for expressing the visible region is not limited to the above example, and the visible region may be expressed as a range for each axis on the reference coordinate axes x-y-z. Information on the calculated visible region is output to the UI position determination unit 1003.

The gaze region calculation unit 1002 calculates a gaze region at which a wearer is gazing based on HMD information obtained from the HMD information obtaining unit 202. Here, “gaze region” refers to a region in the above-mentioned visible region where the wearer can recognize an object included within the region without moving the wearer's line of sight or head. Like the visible region, the gaze region is also expressed as the values of a set of the coordinate values of the center and the radius of a circle on the reference coordinate axes x-y-z, and the calculation method is also the same. However, the angle of view θ used in the calculation is an angle smaller than that used in the calculation of the above-mentioned visible region and may be, for example, three degrees, which is the highest resolution range of human vision. Incidentally, like the visible region, the gaze region can also be expressed in various ways and is not particularly limited. Information on the calculated gaze region is output to the UI position determination unit 1003.

The UI position determination unit 1003 determines in what position in an image to be displayed on the display of the HMD 20 a UI is to be displayed based on the information on the visible region obtained from the visible-region calculation unit 1001 and the information on the gaze region obtained from the gaze region calculation unit 1002. In the present embodiment, the “position” here is expressed by the coordinate values of the upper left of the UI on the reference coordinate axes x-y-z, specifically, coordinate values obtained by adding a three-dimensional vector v to the coordinate values of the center in the gaze region. The three-dimensional vector v in this case is obtained by multiplying a predetermined three-dimensional unit vector e by a coefficient α. The three-dimensional unit vector e is a vector which is the base of the position of the UI. The three-dimensional unit vector e has only to be freely determined according to a direction in which the UI is intended to be displayed. For example, in a case where the UI is intended to be displayed to the right of a position at which the wearer is gazing, the three-dimensional unit vector e=(1, 0, 0). The coefficient α is an adjustment coefficient for making the position in which the UI is to be displayed within the visible region and outside the gaze region. In the above example, a case where one radius value that does not depend on an axis is used has been described, but a different radius value may be used for each axis. In the above example, the position is expressed by the coordinate values of the upper left of the UI, but the coordinate values of the center of the UI may also be used, for example. Incidentally, in the case of using another expression such as the coordinate values of the center, it is necessary to appropriately adjust the coefficient β, the size of the UI, or the like so that the gaze region is not covered with the UI. The UI position determination unit 1003 outputs the determined position information on the UI to the display processing unit 205.

The display processing unit 205 performs general processing for displaying video image contents such as a VR video image and an MR video image and also performs processing for displaying the UI on the display of the HMD 20 based on position information obtained from the UI position determination unit 1003. The general processing for displaying video image contents includes rendering according to the viewing angle of the HMD 20, color conversion processing suitable for the display of the HMD 20, correction processing for correcting distortion of the eyepiece lenses of the HMD 20, and the like.

### Operation Flow of Information Processing Apparatus

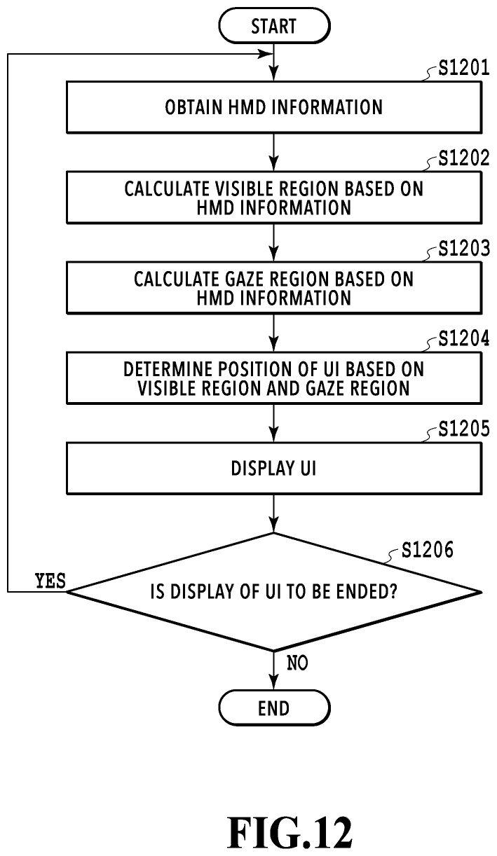

Next, a processing flow in a case where the information processing apparatus 10 according to the present embodiment determines and displays the position of a UI will be described with reference to the flowchart in FIG. 12. A series of steps shown in the flowchart in FIG. 12 is implemented by the CPU 101 expanding a program stored in the ROM 103 into the RAM 102 and executing the program. The series of steps is started in response to a UI display instruction from a wearer who is watching video image contents, and is executed, for example, in units of frames. Incidentally, it is not necessary for all of the steps shown in the flowchart in FIG. 12 to be executed by the CPU 101, and a portion or all of the steps may be executed by one or more processing circuits other than the CPU 101. Incidentally, in the following description, each symbol “S” means a step.

In S1201, the HMD information obtaining unit 202 obtains the above-mentioned HMD information on the current HMD 20. The obtained HMD information is output to the visible-region calculation unit 1001 and the gaze region calculation unit 1002.

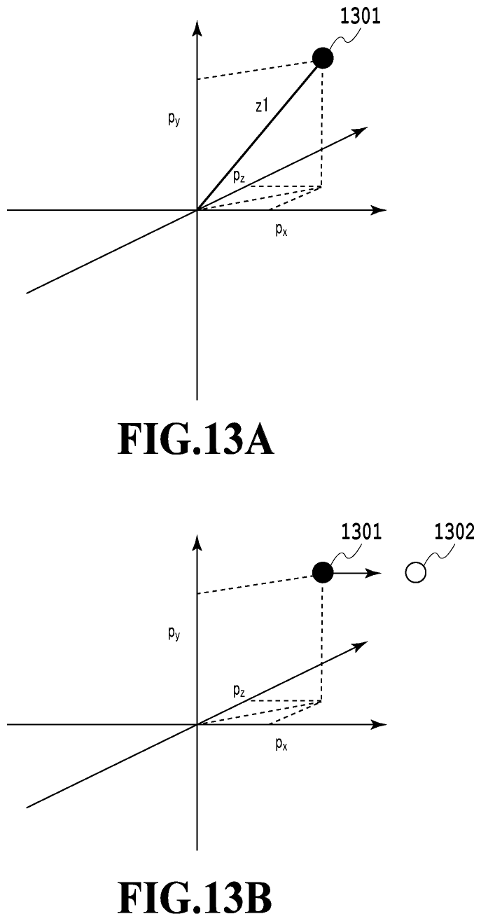

In S1202, the visible-region calculation unit 1001 calculates the visible region visible to the wearer in a frame of interest. FIG. 13A is a diagram for explaining a process for calculating the visible region. In FIG. 13A, a black circle 1301 indicates the position of center coordinate values P=(px, py, pz) in the visible region indicated by line-of-sight information, and the distance z1 to the black circle 1301 is obtained by Equation 1 below.

$${z}_{1} = \sqrt{{p}_{x}^{2} + {p}_{y}^{2} + {p}_{z}^{2}} \qquad Equation 1$$

The radius r of a circle in the visible region is obtained by Equation 2 below.

$$r = {z}_{1} \times tan \frac{θ}{2} \qquad Equation 2$$

Now, it is assumed that the distance z1 is 1000 mm and 0=30 degrees. In this case, the radius r of the circle in the visible region is 267 mm according to Equation 3 above, and a set of the radius r and the center coordinate values P=(px, py, pz) is obtained as information on the visible region.

In S1203, the gaze region calculation unit 1002 calculates a gaze region at which the wearer is gazing in the frame of interest. The calculation method is the same as that for the visible region described above, except that the value of 0 in Equation 2 above is changed. Now, it is assumed that the distance z1 is 1000 mm and 0=3 degrees. In this case, the radius r of the circle in the gaze region is 26 mm according to Equation 2 above, and a set of the radius r and the center coordinate values P=(px, py, pz) is obtained as information on the gaze region.

In S1204, the UI position determination unit 1003 determines a position where a UI is displayed in a region within the visible region and outside the gaze region. FIG. 13B is a diagram for explaining a process for determining the position of the UI based on the visible region and the gaze region. Now, the black circle 1301 indicates the position of the center coordinate values P=(px, py, pz) in the gaze region, and at this time, a position q where the UI is displayed is calculated by q=P+α×e=P+{r2+(r1−r2)×β}×e.

In the above equation, r1 represents the radius of the visible region, and r2 represents the radius of the gaze region. β is any coefficient for fine-adjusting the position where the UI is displayed in the region inside the visible region and outside the gaze region and takes a value in the range of 0 to 1. For example, in a case where ß is set to 0.5, the UI is displayed at the midpoint in the region inside the visible region and outside the gaze region. Since the position q is calculated for each component of x, y, and z, the above equation is expressed as Equation 3 below.

$$[ \begin{matrix}{q}_{x} \\ {q}_{y} \\ {q}_{z}\end{matrix} ] = α \times [ \begin{matrix}1 \\ 0 \\ 0\end{matrix} ] + [ \begin{matrix}{p}_{x} \\ {p}_{y} \\ {p}_{z}\end{matrix} ] \qquad Equation 3$$

Now, it is assumed that the center coordinate values of the gaze region are (0, 0, 1000), the radius r of the visible region is 267 mm, and the radius r of the circle in the gaze region is 26 mm. In this case, α={26+(267−26)×0.5}, and the center coordinate values of a position determined as the display position of the UI is (146, 0, 1000). In FIG. 13B, a white circle 1302 indicates the position of center coordinate values q=(qx, qy, qz) where the UI thus determined is to be displayed.

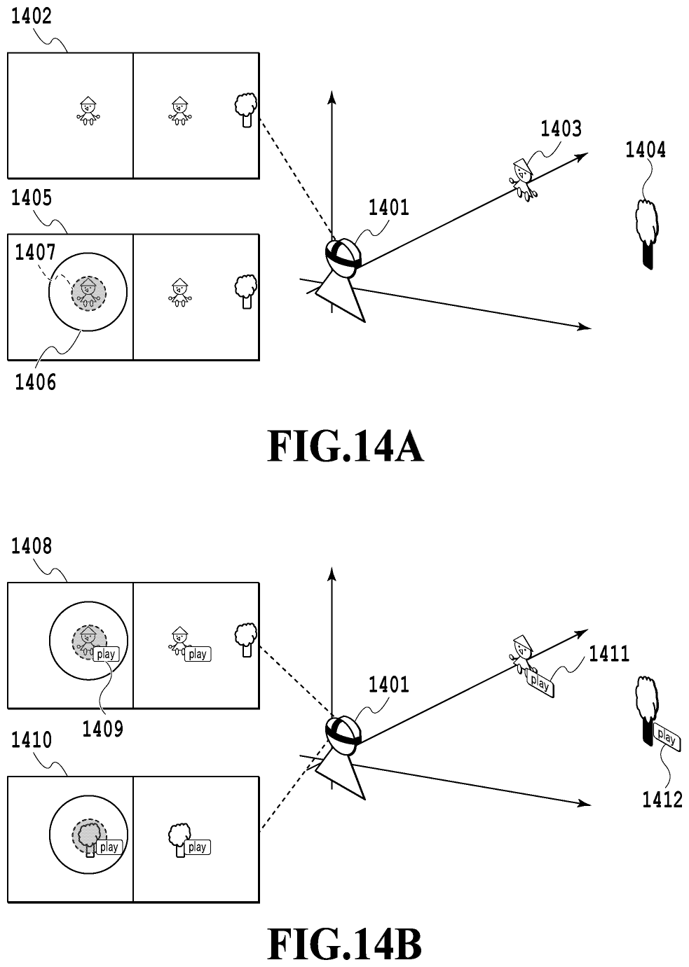

Here, the results of the processing in each step of S1203 and S1204 will be described using specific examples. FIG. 14A is a diagram showing a state where a wearer 1401 of the HMD 20 is watching video image contents. The wearer 1401 can obtain a three-dimensional appearance from a perceived virtual image by viewing different images 1402 with parallax displayed on two left and right displays 402R and 402L through the lenses 401R and 401L, respectively (see FIG. 4A above). Incidentally, the position of the virtual image at this time varies depending on a difference in parallax between the left and right images displayed on the displays 402R and 402L, respectively, and the wearer 1401 perceives an object as existing at a distance according to the parallax. Now, in the image 1402 in which a left-eye image and a right-eye image are arranged and expressed side by side, an object 1403 and an object 1404 are reflected. In a case where the viewing angle of the HMD 20 is 100 degrees, an angle of view corresponding to each eye in the image 1402 is also 100 degrees. In the image 1402, only the object 1403 is reflected in the left-eye image, whereas the two objects 1403 and 1404 are reflected in the right-eye image. This shows a situation where the object 1403 is included in the visual field of one eye but not in the visual field of the other eye because the positions of the left eye and the right eye are different. The wearer 1401 perceives the object 1403 as being present at a distance according to the parallax in the image 1402. In FIG. 14A, an image 1405 is shown by superimposing the visible region 1406 visible to the wearer 1401 calculated in S1202 and the gaze region 1407 calculated in S1203 on the above-mentioned image 1402. FIG. 14B is a diagram showing a state where a UI is displayed in response to an instruction to display the UI from the wearer 1401 in the above-mentioned situation shown in FIG. 14A. In FIG. 14B, as shown in an image 1408, a UI 1409 is displayed inside a visible region 1406 and outside a gaze region 1407. In this case, in a case where the UI overlaps the object 1403 reflected in the gaze region 1407, the UI becomes an obstacle, and in a case where the UI is displayed outside the visible region 1406, the wearer 1401 cannot immediately visually identify the UI and must perform an action such as moving the wearer 1401's head. In the case of the present embodiment, since the UI is displayed inside the visible region 1406 visible to the wearer 1401 and outside the gaze region 1407 at which the wearer 1401 is gazing, the UI does not become an obstacle during viewing and the wearer 1401 can immediately find the UI without fail, and wearer operability increases. Incidentally, the UI to be displayed is not particularly limited, and can be applied to various members such as a button for giving an instruction to play back/stop video image contents, a display list of file names, and a window for inputting or changing various settings.

In S1205, the display processing unit 205 displays the UI in the position determined in S1204. In this case, the UI may be generated and displayed on a layer different from that of the image of the video image contents or may be displayed by being synthesized with the image of the video image contents. The case where one UI is displayed has been described above, but the present disclosure is not limited to this, and a plurality of UIs may be displayed. In the case of displaying a plurality of UIs, all UIs may be displayed within the visible region and outside the gaze region, or only a primary UI may be displayed within the visible region and outside the gaze region, and a non-primary UI may be displayed outside the visible region.

In S1206, it is determined whether to end the display of the UI. In a case where the purpose of the UI is achieved by the wearer inputting an instruction to stop the UI, by receiving input of a necessary command on the displayed UI, or the like, the present process ends. On the other hand, in a case where the display of the UI continues, the process returns to S1201 and continues.

The above is the processing flow in a case where the position of the UI is determined and displayed according to the present embodiment. Through such processing, the position of the UI is updated in units of frames. As a result, for example, in a case where the line of sight direction of the wearer changes in a situation where the UI is displayed and, for example, the object seen by the wearer changes from the image 1408 to an image 1410 in FIG. 14B, the three-dimensional position of the UI also changes following the line-of-sight direction. That is, the three-dimensional display position of the UI changes from a position 1411 to a position 1412.

### First Modification Example

In a situation where a UI is displayed while video image contents are being played back, the line of sight (≈gaze region) of a wearer of the HMD 20 may move back and forth between the video image contents and the UI. In such a situation, in the above-described embodiment, the position of the UI may change frequently, which may cause the UI to flicker and hinder viewing of the video image contents. Thus, as a first modification example, an aspect will be described in which the position of the UI is not changed while the currently displayed UI is included in the visible region, and the position of the UI is changed only in a case where the currently displayed UI is not included in the visible region.

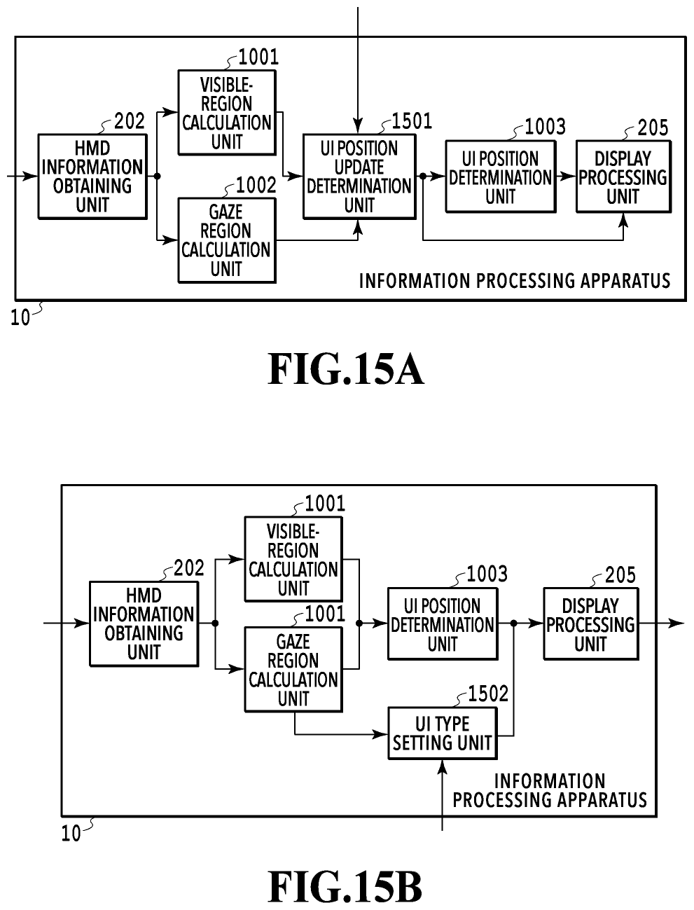

FIG. 15A is a block diagram showing an internal configuration of the information processing apparatus 10 according to the present modification example. A difference from the block diagram shown in FIG. 10 described above is that a UI position update determination unit 1501 is added. In the present modification example, the visible-region calculation unit 1001 outputs obtained information on the visible region to the UI position update determination unit 1501. The UI position update determination unit 1501 determines whether to change the position of the UI based on the visible region calculated by the visible-region calculation unit 1001 and the current position of the UI held in the RAM 102 by comparing the visible region with the current position of the UI. As described in the above embodiment, the visible region and the position of the UI are expressed on the same three-dimensional coordinate axes. The UI position update determination unit 1501 determines not to change the position in a case where the coordinate values of the UI are included in the range of the visible region and determines to change the position in a case where the coordinate values of the UI are not included in the range of the visible region. In a case where it is determined to change the position, the UI position update determination unit 1501 outputs information on the visible region calculated by the visible region calculation unit 1001 to the UI position determination unit 1004, and in a case where it is determined not to change the position, the UI position update determination unit 1501 outputs information on the current position of the UI read from the RAM 102 to the display processing unit 205. The UI position determination unit 1003 outputs information on the determined display position of the UI to the display processing unit 205 and also holds the information in the RAM 102.

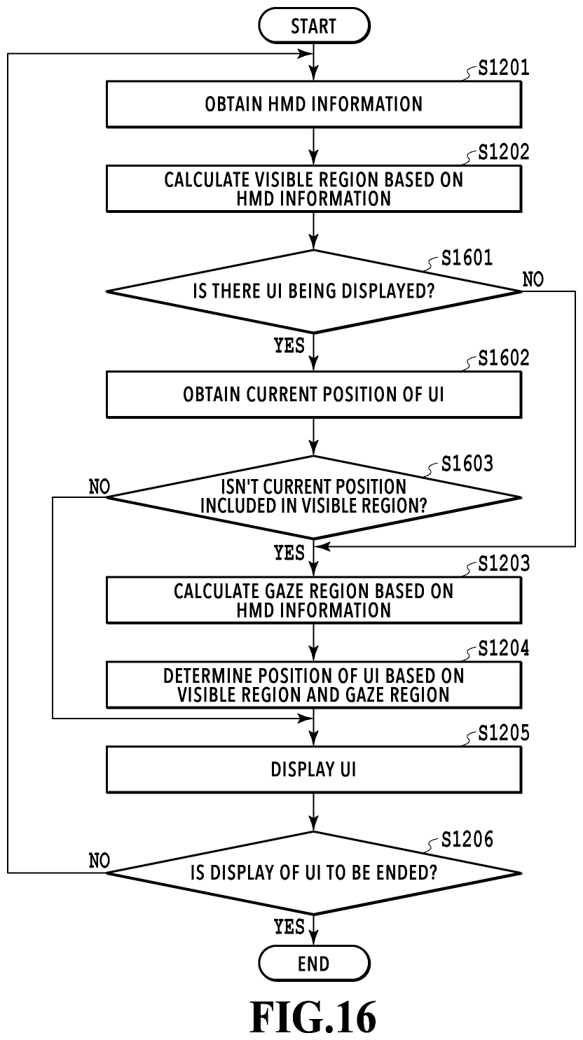

FIG. 16 is a flowchart showing a processing flow in a case where the information processing apparatus 10 according to the present modification example determines and displays the position of a UI. The following description will be given with reference to the flowchart in FIG. 16, but the same reference number is given to the same step as in the flowchart in FIG. 12 according to the above-mentioned second embodiment, and a description thereof will be omitted.

After the calculation of the visible region (S1202) is completed, a step to be executed next is determined in S1601 depending on whether there is a UI currently being displayed. In a case where a UI is already being displayed, S1602 is executed next. On the other hand, in a case where a UI has not been displayed, S1203 is executed next.

In S1602, the UI position update determination unit 1501 obtains information on the current three-dimensional position of the UI being displayed. In subsequent S1603, the UI position update determination unit 1501 then performs the above-mentioned determination process. A step to be executed next is then determined according to a determination result. That is, in a case where no UI is included in the visible region, it is determined to change the position of the UI (Yes in S1603), and S1203 is executed next to determine the new position of the UI. On the other hand, in a case where the UI is included in the visible region, it is determined not to change the position of the UI (No in S1603), S1203 and S1204 are skipped, and S1205 is executed. As a result, the current position of the UI is maintained.

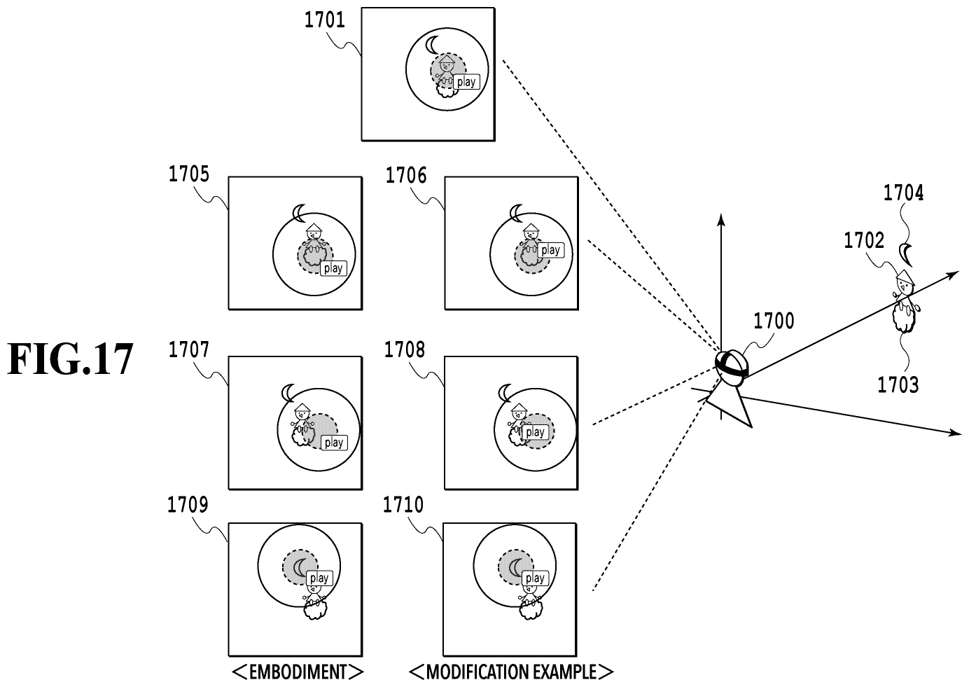

The above is the processing flow in a case where the information processing apparatus 10 according to the present modification example determines and displays the position of the UI. Here, the behavior of the UI in the present modification example will be specifically described with reference to FIG. 17. In FIG. 17, an image 1701 shows an image corresponding to one of the left and right eyes displayed on the display of the HMD 20. In the image 1701, a visible region visible to a wearer 1700 is shown by a solid circle, and a gaze region at which the wearer 1700 is gazing is shown by a dashed circle, and the wearer 1700 is in a state of focusing on an object 1702. In FIG. 17, of two image groups of three images arranged one above the other below the image 1701, a left image group 1705, 1707, 1709 corresponds to the method according to the embodiment, and a right image group 1706, 1708, 1710 corresponds to the method according to the present modification example.

First, it is assumed that the wearer 1700 moves the wearer 1700's line of sight to an object 1703 while a UI is being displayed within the visible region and outside the gaze region. In this case, according to the method according to the above-described embodiment, the UI is displayed in a position shown in the image 1705. In contrast, according to the present modification example, as shown in the image 1706, the position of the UI does not change from a position before the line of sight is changed (image 1701).

Next, in a case where the wearer 1700 moves the wearer 1700's line of sight to the UI while the UI is still displayed in the position shown in the image 1701, according to the method according to the above-described embodiment, the UI is displayed in the position shown in the image 1707. In contrast, according to the present modification example, as shown in the image 1708, the position of the UI does not change from the position before the line of sight is changed (image 1701).

Next, it is assumed that the wearer 1700 moves the wearer 1700's line of sight to the object 1704 while the UI is still displayed in the position shown in the image 1701. In this case, the currently displayed UI is outside the visible region. Therefore, whether by the method according to the above-described embodiment or the method according to the present modification example, the position of the UI is changed to within the visible region and outside the gaze region. Thus, as is clear from a comparison between the images 1709 and 1710, the UI is displayed in the same position by both methods.

As described above, according to the present modification example, in a situation where a UI is displayed during playback of video image contents, whether to change the position of the UI being displayed is controlled based on a relationship between the visible region and the display position of the UI. This makes it possible to suppress flickering of the UI caused by a change in a wearer's line of sight.

### Second Modification Example

In a case where a UI does not enter the gaze region even after a certain period of time has elapsed since the UI was displayed on the display, there is a possibility that a wearer is not aware of the UI. Thus, as a second modification example, an aspect will be described in which a UI display form is changed so that the wearer can easily notice the UI.

FIG. 15B is a block diagram showing an internal configuration of the information processing apparatus 10 according to the present modification example. A difference from the block diagram shown in FIG. 10 described above is that a UI type setting unit 1502 is added. In the present modification example, the gaze region calculation unit 1002 outputs obtained information on the visible region to the UI position determination unit 1003 and the UI type setting unit 1502. The UI position determination unit 1003 outputs information on the determined display position of a UI to the display processing unit 205 and holds the information in the RAM 102. The UI type setting unit 1502 sets the type of UI to be displayed according to the current situation. In the present embodiment, there are three types of UI that may be set: “normal” which is a reference display form, “highlighted” which makes the UI more noticeable than in the reference display form, and “suppressed” which makes the UI less noticeable than in the reference display form. Here, “highlighted” is, for example, fine adjustment of the size/position of the UI, blinking of the UI, or the like. Further, “suppressed” includes, for example, reduction of the size of the UI, transparency of the UI, or the like. The display forms of “highlighted” and “suppressed” are not limited to the above examples and include changes in the display form according to the purpose. A specific setting method will be described later. The UI type setting unit 1502 outputs information on the set type of UI to the display processing unit 205. The display processing unit 205 displays a UI based on UI position information obtained from the UI position determination unit 1003 and UI type information obtained from the UI type setting unit 1502. The display processing unit 205 also measures elapsed time from the start of display of the UI being displayed of the current type and outputs the time together with type information to the UI type setting unit 1502. The elapsed time is reset by changing the type of UI or stopping the display of the UI.

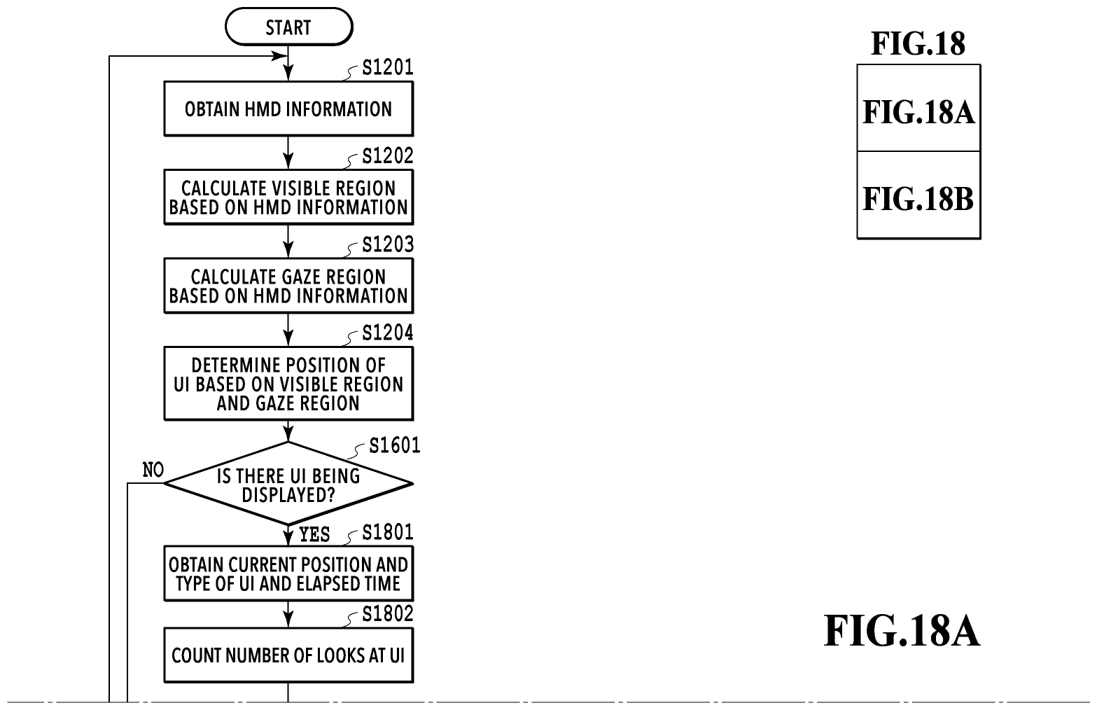

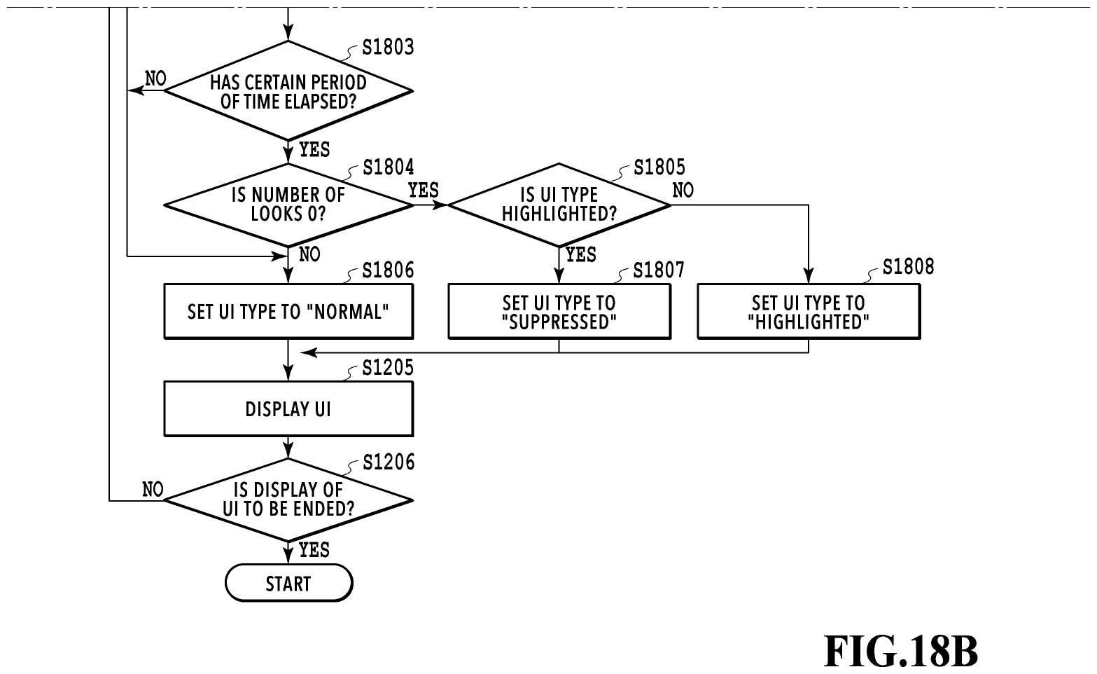

FIGS. 18A and 18B are flowcharts showing a processing flow in a case where the information processing apparatus 10 according to the present modification example determines and displays the position of a UI. The following description will be given with reference to the flowchart in FIGS. 18A and 18B, but the same reference number is given to the same step as in the flowchart in FIG. 12 according to the above-mentioned second embodiment and in the flowchart in FIG. 16 according to the above-mentioned first modification example, and a description thereof will be omitted.

In a case where the position of the UI is determined based on the visible region and the gaze region (S1204), a step to be executed next is determined depending on whether there is a UI currently being displayed in S1601. In a case where a UI is already being displayed, S1801 is executed next. On the other hand, in a case where a UI has not been displayed, S1806 is executed next. S1801 to S1808 are executed by the UI type setting unit 1502.

In step S1801, information on the position and type of the UI being displayed and elapsed time from the start of display of the UI is obtained. The position of the UI being displayed is read out and obtained from the RAM 102, and the type of UI and the elapsed time are obtained from the display processing unit 205.

In S1802, the number of times (the number of looks) the wearer has looked at the UI being displayed is counted. Specifically, it is determined whether the position of the UI being displayed obtained in S1801 is included in the gaze region determined in S1204, and in a case where the position of the UI being displayed obtained in S1801 is included in the gaze region determined in S1204, a counter value is incremented (+1). This counter value is held and updated in the RAM 102 and is reset in response to a change in the type of UI or stopping of the display of the UI. As described above, since the gaze region and the position of the UI are expressed on the same three-dimensional coordinate axes, it is possible to determine whether the position of the UI being displayed is included in the gaze region by comparing the coordinate values of the UI with the range of the gaze region.

In S1803, a step to be executed next is determined depending on whether the elapsed time obtained in S1801 is equal to or greater than a predetermined certain period of time. In a case where the elapsed time is equal to or greater than the certain period of time, S1804 is executed next. On the other hand, in a case where the elapsed time is less than the certain period of time, S1806 is executed next.

In S1804, a step to be executed next is determined according to the number of looks obtained in S1802. Here, in a case where the number of looks is 0, S1805 is executed next. On the other hand, in a case where the number of looks is 1 or more, S1806 is executed next.

In S1805, a step to be executed next is determined depending on whether the current type of UI obtained in S1801 is “highlighted.” In a case where the current type of UI is “highlighted,” S1807 is executed next. On the other hand, in a case where the current type of UI is not “highlighted,” S1808 is executed next. In S1806, the type of UI is set to “normal,” in S1807, the type of UI is set to “suppressed,” and in S1808, the type of UI is set to “highlighted.”

The above is the processing flow in a case where the information processing apparatus 10 according to the present modification example determines and displays the position of a UI. Here, the behavior of a UI in the present modification example will be described using specific examples.

### First Case

First, it is assumed that after a wearer issues an instruction to display a UI and the UI is displayed, the UI remains out of the gaze region even after a certain period of time has elapsed. In this case, there is a possibility that the wearer is not aware of the UI being displayed. Thus, control is performed to change the type of UI from “normal” to “highlighted.” That is, the result is Yes in S1803, Yes in S1804, and No in S1805, and the type of UI is set to “highlighted” in S1808. In this way, a display process is performed to make the UI noticeable so that the wearer can easily notice the UI.

### Second Case

It is assumed that after the display of the UI is changed to be more noticeable, the UI remains out of the gaze region even after a certain period of time has elapsed. In this case, there is a possibility that the wearer is aware of the UI being displayed but thinks that the UI is unnecessary at the moment. Thus, control is performed to change the type of UI from “highlighted” to “suppressed.” That is, the result is Yes in S1803, Yes in S1804, and Yes in S1805, and the type of UI is set to “suppressed” in S1807. In this way, a display process is performed to make the UI less noticeable so that the wearer does not need to be concerned about the UI.

In S1804 described above, the number of looks used as a criterion for determination is set to 0, but the number may be, for example, 1 or more. Instead of counting the number of looks, a binary flag expressing whether the wearer has seen or not seen the UI may be used. As a process in a case where the type of UI is set to “suppressed,” the UI may be dismissed from the screen.

According to the present modification example, in a situation where a UI is displayed during playback of video image contents, the display mode of the UI is controlled based on the posture of a wearer toward the UI. As a result of this, the UI is displayed so as to be easily found in the case of being deemed necessary, and is displayed so as to be less noticeable if unnecessary, thereby increasing user convenience.

As described above, according to the present embodiment including the various modification examples, it is possible to display a UI in an appropriate position at the time of watching a video image using an HMD.

The technique according to Japanese Patent Laid-Open No. 2012-15620 described above has a problem in that, in a case where a scene is switched from a distant view video image to a close-range view video image, for example, while a wearer is experiencing a stereoscopic image with an HMD, the focus adjustment function of the wearer's eyes cannot keep up with a sudden change in distance to an object, which causes eye strain. In addition, the technique according to Japanese Patent Laid-Open No. 2018-45459 (Patent Literature 2) described above has a problem in that, in a case where a wearer operates a UI for inputting commands or the like while watching, for example, a VR video image or an MR video image, the UI may hide contents depending on a position where the UI is displayed, which hinders the wearer from viewing the video image. According to the technique of the present disclosure, suitable video image experience can be provided to a user experiencing an XR video image using an HMD.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-117836, filed Jul. 23, 2024, which is hereby incorporated by reference herein in its entirety.

What is claimed is:

1. An information processing apparatus generating a virtual reality image to be stereoscopically displayed with a head-mounted display device, the information processing apparatus comprising:
one or more memories storing instructions; and
one or more processors executing the instructions to:
obtain, as material data for generating the virtual reality image, a stereoscopic image capable of expressing two images having parallax from each other and information regarding the parallax corresponding to the stereoscopic image; and
generate a virtual reality image applied to specific processing to make it easier for eyes of a user wearing the display device to focus in a case where a difference in parallax between different frames of the stereoscopic image is greater than a threshold.

2. The information processing apparatus according to claim 1, wherein the difference in parallax between the different frames of the stereoscopic image is a difference in parallax in an observation region viewed by the user in the stereoscopic image.

3. The information processing apparatus according to claim 2, wherein the one or more processors execute the instructions to:
obtain orientation information on the display device; and
identify the observation region in the different frames of the stereoscopic image based on the orientation information, wherein
in a case where the difference in parallax in the observation region is greater than a threshold, a virtual reality image applied to the specific processing is generated.

4. The information processing apparatus according to claim 1, wherein the specific processing is processing for reducing visibility.

5. The information processing apparatus according to claim 4, wherein the processing for reducing the visibility is processing for adding a blur to a region with a difference in parallax greater than a threshold in the stereoscopic image.

6. The information processing apparatus according to claim 4, wherein the processing for reducing the visibility is processing for reducing illuminance.

7. The information processing apparatus according to claim 4, wherein the processing for reducing the visibility is processing for reducing contrast.

8. The information processing apparatus according to claim 4, wherein the processing for reducing the visibility is processing for reducing a color difference.

9. The information processing apparatus according to claim 1, wherein the specific processing is processing for making a match with a line of sight direction in which the difference in parallax between the different frames is reduced.

10. The information processing apparatus according to claim 3, wherein the one or more processors execute the instructions to:
calculate a degree of vision influence in a case where the difference in parallax is greater than a threshold, wherein
in a case where the degree of vision influence is greater than a threshold, a virtual reality image applied to the specific processing is generated.

11. The information processing apparatus according to claim 10, wherein the degree of vision influence is calculated based on a viewpoint such that as visibility of an object present in the observation region in which the difference in parallax is determined to be greater than the threshold is higher, the degree of vision influence takes a greater value.

12. The information processing apparatus according to claim 11, wherein the degree of vision influence is a value obtained by making an evaluation from any one of viewpoints of a size, a blur amount, and luminance of the object in the stereoscopic image.

13. The information processing apparatus according to claim 3, wherein the one or more processors execute the instructions to:
analyze a change over time in an observation distance in a case where the difference in parallax is greater than the threshold, wherein
in a case where elapsed time during which a state where the observation distance is not changed continues exceeds a threshold, a virtual reality image applied to the specific processing is generated.

14. A method for controlling an information processing apparatus generating a virtual reality image to be stereoscopically displayed with a head-mounted display device, the method comprising the steps of:
obtaining, as material data for generating the virtual reality image, a stereoscopic image capable of expressing two images having parallax from each other and information regarding the parallax corresponding to the stereoscopic image; and
generating a virtual reality image applied to specific processing to make it easier for eyes of a user wearing the display device to focus in a case where a difference in parallax between different frames of the stereoscopic image is greater than a threshold.

15. A non-transitory computer readable storage medium storing a program for causing a computer to perform a method for controlling an information processing apparatus generating a virtual reality image to be stereoscopically displayed with a head-mounted display device, the method comprising the steps of:
obtaining, as material data for generating the virtual reality image, a stereoscopic image capable of expressing two images having parallax from each other and information regarding the parallax corresponding to the stereoscopic image; and
generating a virtual reality image applied to specific processing to make it easier for eyes of a user wearing the display device to focus in a case where a difference in parallax between different frames of the stereoscopic image is greater than a threshold.
